(19) United States
(12) Patent Application Publication
(10) Pub. No.: US 2005/0212775 A1
(43) Pub. Date: Sep. 29, 2005

(54) Apparatus for detecting touched-position using surface acoustic wave

(76) Inventor: Young Jin Lee, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/852,430

(22) Filed: May 25, 2004

(30) Foreign Application Priority Data
Mar. 29, 2004 (KR) 2004-21354

(51) Int. Cl. G09G 5/00

(52) U.S. Cl. 345/173

(57) ABSTRACT

A touched-position detection device detects a touched position by measuring a propagation time of a SAW (Surface Acoustic Wave) signal generated on a touch panel. The touched-position detection device using the SAW signal includes: a touch panel; a controller for controlling signal generation and a signal generation time; an impulse signal generator for generating an impulse signal; a SAW generator for converting the impulse signal generated from the impulse signal generator into a SAW signal on the touch panel; a SAW sensor for detecting the SAW signal received via the touch panel's surface; a signal analyzer for classifying the SAW signal detected by the SAW sensor into a DW (Direct Surface Wave) signal and an RW (Reflected Surface Wave) signal according to the SAW signal intensity so as to identify the SAW signal, and measuring arrival times of the DW and RW signals upon receiving arrival times of the DW and RW signals and the signal control time of the controller; and a position calculator for calculating the touched positions x and y on the touch panel upon receiving the arrival times from the signal analyzer.

### BACKGROUND OF THE INVENTION

1. Field of the Invention

The present invention relates to a touched-position detection device for use in a position detection system such as a touch pad and a touch screen, etc., and more particularly to a touched-position detection device using a surface acoustic wave with low power consumption, which generates a surface acoustic wave at one end of a touch panel to detect the surface acoustic waves at more than two positions contained in the other end of the touch panel, and measures a propagation time of the surface acoustic wave to detect a contact point position, such that it can be implemented in the form of a simple configuration, and can improve a resolution and a detection speed because it uses an ultrasound propagation time.

2. Description of the Related Art

Typically, conductive films and infrared matrices have been most often adapted as representative touch panels. The conductive film is formed of a thin metal plate attached to lateral surfaces of X and Y axes where chemicals are deposited between a glass layer and a thin film layer. If a power-supply voltage is applied to such a touch panel, predetermined resistance is created. If a user's hand or other objects are brought in contact with one part of the touch panel, chemicals react to the touched part, such that resistance is instantaneously changed, and a lateral metal plate of the touch panel is designed to search for a position coordinate at which the object is located upon receipt of the resistance variation.

The infrared matrix is configured in the form of an array composed of infrared emitters and infrared sensors, such that infrared rays configured in the form of a dense matrix can flow in the touch panel in four directions (i.e., right and left directions, and upper and lower directions). If an object is brought in contact with a specific section of the touch panel, infrared rays flowing in the specific section are blocked, such that the principles for recognizing position information of the contact object by detecting the blocked infrared rays can be used.

In addition to the aforementioned conductive film and infrared matrix schemes, a capacitance variation scheme, a metal-fine-line reclamation scheme, a pressure sensor scheme, and a surface acoustic wave scheme have principles and configurations similar to those of the conductive film and infrared matrix schemes.

There are several problems in the aforementioned conventional position detection device, and their detailed descriptions will hereinafter be described.

The conductive film has a weak surface whereas it can finely detect position information of its contact point, resulting in deteriorated durability and a complicated panel fabrication process. The infrared matrix must densely arrange small-sized infrared emitters and sensors therein to enhance its resolution, resulting in an increased production cost and increased power consumption, and a complicated signal process. Furthermore, the aforementioned array scheme has a disadvantage in that it cannot further increase its resolution due to its fabrication limitation by which the sensors cannot be more densely arranged in the array.

In this way, the capacitance variation scheme, the metal-fine-line reclamation scheme, the pressure sensor scheme, and the surface acoustic wave scheme also have the same problems as those of the aforementioned infrared matrix and conductive film schemes.

A representative scheme from among the aforementioned schemes will hereinafter be described with reference to FIG. 1.

The conventional position detection device shown in FIG. 1 has been disclosed in U.S. Pat. No. 6,593,917, which is incorporated herein by reference. Referring to FIG. 1, the conventional position detection device for detecting a touched position using ultrasonic waves includes a first switch 3 for transmitting a first input electrode signal to input electrodes Tx1˜Tx5; a second switch 4 for transmitting a second input electrode signal to input electrodes Ty1˜Ty5; and a signal analyzer 2 for detecting signals received via electrodes Gx1˜Gx5 and Gy1˜Gy5 of a nonmagnetic plate 1. Individual electrode signals Uxi of the electrodes Gx1˜Gx5 arrive at the second interdigital electrode pair 11 via the signal analyzer 2, the first interdigital electrode 10 on the fifth piezoelectric substrate 9, and the first synchronizer 13, such that they are converted into a SAW (Surface Acoustic Wave) configured in the form of a burst signal and arrive at the electrode 12. Individual electrode signals Uyj of the electrodes Gy1˜Gy5 arrive at the fifth interdigital electrode pair 16 via the signal analyzer 2, the fourth interdigital electrode 15 on the sixth piezoelectric substrate, and the second synchronizer 18, such that they are converted into a SAW (Surface Acoustic Wave) configured in the form of a burst signal and arrive at the electrode 17.

The aforementioned burst-signal-shaped SAWs are transmitted to the signal analyzer 2, resulting in greater clarification of their amplitude states. In this case, the amplitudes are indicative of two neighbor electrodes, such that a phase state between the burst-signal-shaped SAWs can be identified and a touched position can also be detected.

However, the aforementioned conventional position detection device has an array structure where sensors corresponding to individual electrodes are arranged to detect the touched position, such that it has a disadvantage in that it must more densely arrange sensors therein to improve its resolution, resulting in an increased production cost, increased power consumption, and a complicated signal process.

### SUMMARY OF THE INVENTION

Therefore, the present invention has been made in view of the above problems, and it is an object of the invention to provide a touched-position detection device using a surface acoustic wave with low power consumption, which generates a surface acoustic wave at one end of a touch panel to detect the surface acoustic waves at more than two positions contained in the other end of the touch panel, and measures a propagation time of the surface acoustic wave to detect a contact point position, such that it can be implemented in the form of a simple configuration, and can improve a resolution and a detection speed because it uses an ultrasound propagation time.

In accordance with the present invention, these objects are accomplished by providing a touched-position detection device using a surface acoustic wave (SAW) signal, comprising: a touch panel formed of a non-directional material associated with a SAW; a controller for controlling signal generation and a signal generation time; an impulse signal generator for generating an impulse signal upon receiving a control signal from the controller; a SAW generator installed at one corner of the touch panel to convert the impulse signal generated from the impulse signal generator into a SAW signal on the touch panel; a SAW sensor including piezoelectric vibration sensors installed at more than two points contained in the touch panel, each piezoelectric vibration sensor detecting the SAW signal received via the touch panel's surface; a signal analyzer for classifying the SAW signal detected by the SAW sensor into a DW (Direct Surface Wave) signal and an RW (Reflected Surface Wave) signal according to intensity information of the SAW signal so as to identify the SAW signal, and measuring arrival times of the DW signal and other arrival times of the RW signal upon receiving arrival times of the DW and RW signals and the signal control time of the controller; and a position calculator for calculating the touched positions x and y on the touch panel upon receiving the arrival times from the signal analyzer.

### BRIEF DESCRIPTION OF THE DRAWINGS

The above objects, and other features and advantages of the present invention will become more apparent after reading the following detailed description when taken in conjunction with the drawings, in which:

FIG. 1 is a circuit diagram illustrating a conventional position detection device;

FIG. 2 is a circuit diagram illustrating a touched-position detection device in accordance with the present invention;

FIG. 3 is a conceptual view illustrating a direct surface wave (DW) signal and a reflected surface wave (RW) signal for use in the touched-position detection device of FIG. 2 in accordance with the present invention;

FIG. 4a is a waveform diagram illustrating an arrival distance of the direct surface wave (DW) signal and the reflected surface wave (RW) signal in accordance with the present invention; and

FIG. 4b is a waveform diagram illustrating the direct surface wave (DW) signal and the reflected surface wave (RW) signal in accordance with the present invention.

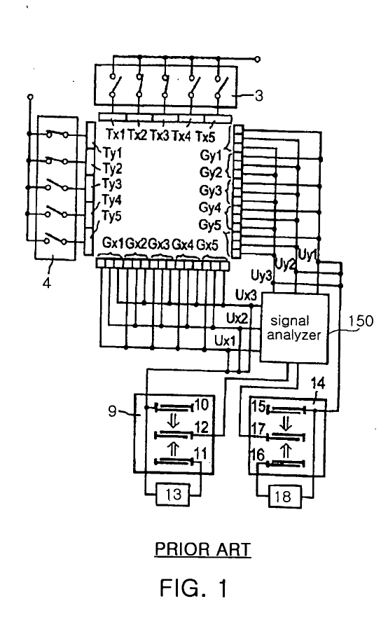

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

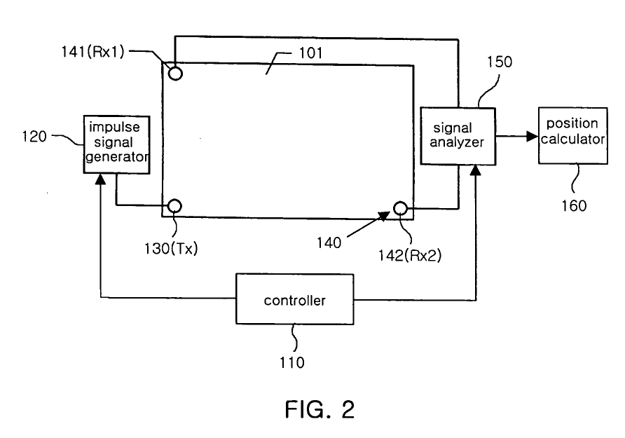

FIG. 2 is a circuit diagram illustrating a touched-position detection device in accordance with the present invention.

Referring to FIG. 2, the touched-position detection device of the present invention includes a touch panel 101 formed of a non-directional material associated with a SAW; a controller 110 for controlling signal generation and a signal generation time t0; an impulse signal generator 120 for generating an impulse signal upon receiving a control signal from the controller 110; a SAW generator 130 installed at one corner of the touch panel 101 to convert the impulse signal generated from the impulse signal generator 120 into a SAW signal on the touch panel 101; a SAW sensor 140 including piezoelectric vibration sensors 141 and 142 installed at more than two points contained in the touch panel 101, each piezoelectric vibration sensor 141 or 142 detecting a SAW signal received via the touch panel 101's panel; a signal analyzer for classifying the SAW signal detected by the SAW sensor 140 into a DW signal and an RW signal according to the SAW signal intensity, identifying the SAW signal, and measuring arrival times ta and tb of the DW signal and arrival times ta2 and tb2 of the RW signal upon receiving arrival times of the DW and RW signals and the signal control time t0 of the controller 110; and a position calculator 160 for calculating the touched positions x and y on the touch panel 101 upon receiving the arrival times ta, tb, ta2, and tb2 from the signal analyzer 150.

Preferably, the touch panel 101 may be formed of a material having a low isotropic attenuation coefficient, such that it can quickly transmit with low attenuation. Preferably, the touch panel may use hard isotropic materials having non-directionality and a low attenuation coefficient on its surface, for example, glass, polymer, metal, and ceramic materials, etc.

The SAW generator 130 is adapted to convert a body wave to a SAW signal, and its ultrasound generator must be small in size to provide the SAW signal with non-directionality. For example, a piezoelectric ultrasound generator and an impact hammer, etc. may be adapted as the SAW generator 130.

Preferably, the SAW sensor 140 may be implemented with a piezoelectric vibration sensor having a short ring-down time and high sensitivity.

Upon receiving individual arrival times of the DW and RW signals and the signal control time t0 of the controller 110, the signal analyzer 150 calculates a difference between the arrival time of the DW signal and the signal control time t0, such that it can calculate the arrival times ta and tb of the DW signal. Also, the signal analyzer 150 calculates a difference between the arrival time of the RW signal and the signal control time t0, such that it can calculate the arrival times ta2 and tb2 of the RW signal.

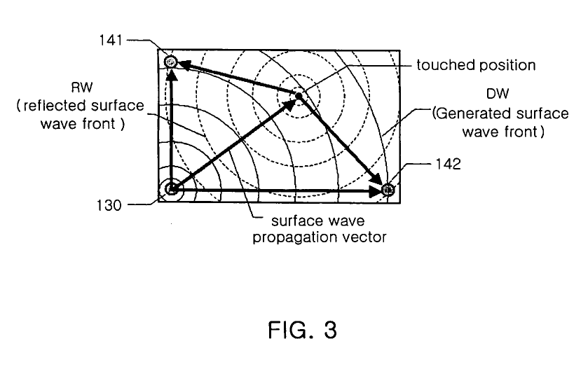

FIG. 3 is a conceptual view illustrating a direct surface wave (DW) signal and a reflected surface wave (RW) signal for use in the touched-position detection device of FIG. 2.

Referring to FIG. 3, the signal, which is generated from the SAW generator 130 and is directly detected by the SAW sensor 140, is called a direct surface wave (DW) signal, and the other signal, which is generated from the SAW generator 130, is reflected from the touched position, and is detected by the SAW sensor 140, is called a reflected surface wave (RW) signal. In this case, the touched position is indicative of a specific position brought in contact with either a user's finger or other touch tools.

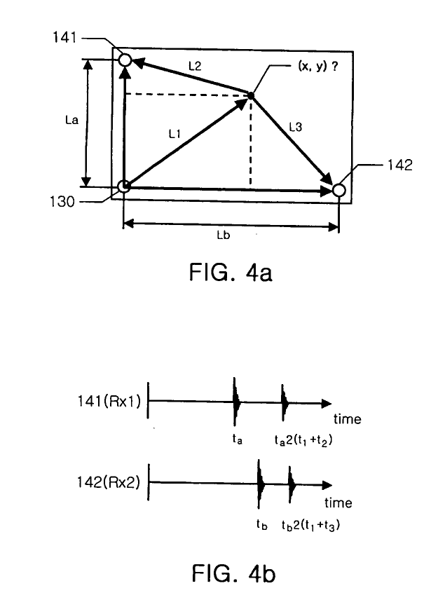

FIG. 4a is a waveform diagram illustrating an arrival distance of the direct surface wave (DW) signal and the reflected surface wave (RW) signal. FIG. 4b is a waveform diagram illustrating the direct surface wave (DW) signal and the reflected surface wave (RW) signal.

Referring to FIG. 4a, in the case where the SAW sensor 140 includes first and second piezoelectric vibration sensors 141 and 142 installed at two corners of the other end of the touch panel 101, the reference character La is a distance from the SAW generator 130 to the first piezoelectric vibration sensors 141 of the SAW sensor 140, the reference character Lb is a distance from the SAW generator 130 to the second piezoelectric vibration sensor 142 of the SAW sensor 140, the reference character L1 is a distance from the SAW generator 130 to the touched position, the reference character L2 is a distance from the touched position to the first piezoelectric vibration sensor 141, and the reference character L3 is a distance from the touched position to the second piezoelectric vibration sensor 142.

Referring to FIG. 4b, the reference character ta is a time during which the DW signal is transferred from the SAW generator 130 to the first piezoelectric vibration sensor 141 of the SAW sensor 140, and is equal to the distance La. The reference character tb is a time during which the DW signal is transferred from the SAW generator 130 to the second piezoelectric vibration sensor 142 of the SAW sensor 140, and is equal to the distance Lb. Furthermore, the reference character t1 is equal to the distance L1, the reference character t2 is equal to the distance L2, and the reference character t3 is equal to the distance L3.

The touched-position detection device of the present invention generates a SAW signal at one end of the touch panel, detects the SAW signal at more than two points contained in the other end of the touch panel, and measures a propagation time of the detected SAW signal, such that it detects a position of the touched-position (i.e., a contact point), and its detailed description will hereinafter be described with reference to FIGS. 2 to 4.

Referring to FIG. 2, the controller 110 of the touched-position detection device of the present invention controls a signal generation function of the impulse signal generator 120, and the signal generation time t0 of the signal analyzer 150. The impulse signal generator 120 generates an impulse signal according to a control signal of the controller 110, and outputs the impulse signal to the SAW generator 130.

In the case where the SAW generator 130 converts the impulse signal generated from the impulse signal generator 120 into a SAW signal generated on the touch panel 101 at one end corner of the touch panel 101, the SAW signal on the touch panel 101 is propagated from one end corner indicative of a signal generation point to the other end of the touch panel 101's surface. In this case, where the touch panel 101 is formed of a low isotropic attenuation coefficient material having non-directionality associated with the SAW signal, the SAW signal can be quickly transmitted to a desired destination with low attenuation.

In the meantime, referring to FIG. 3, the SAW signal on the touch panel 101 may be transmitted from the SAW generator 130 to individual sensors of the SAW sensor 140 as a DW signal. Also, the SAW signal generated from the SAW generator 130 may be reflected from the touched position, such that its RW signal may be transmitted to individual sensors of the SAW sensor 140.

In more detail, as for the DW signal, an ultrasound signal generated from the SAW generator 130 (Tx) is converted into a SAW signal, and the SAW-shaped ultrasound signal arrives at the first and second piezoelectric vibration sensors 141 (Rx1) and 142 (Rx2), such that it has propagation times ta and tb in association with the propagation distances La and Lb. If there arises a touched position (i.e., a contact part) in the touch panel 101, the RW signal is generated from the touched position indicative of a contact part as shown in FIG. 3. In this case, the RW signal is propagated to the first and second piezoelectric vibration sensors 141 (Rx1) and 142 (Rx2) so that the first and second piezoelectric vibration sensors can detect the RW signal.

Thereafter, individual piezoelectric vibration sensors 141 and 142 of the SAW sensor 140 detect a SAW signal including the DW and RW signals propagated via the touch panel 101's surface, and output the detected SAW signal to the signal analyzer 150.

The signal analyzer 150 classifies the SAW signal detected by the SAW sensor 140 into the DW signal and the RW signal according to the SAW signal intensity, such that it can identify the DW signal and the RW signal according to the SAW signal intensity. For example, if the detected SAW signal is higher than a predetermined DW reference value, the signal analyzer 150 determines the SAW signal to be a DW signal. If the detected SAW signal is in the range from the DW reference value to a predetermined RW reference value, the signal analyzer 150 determines the SAW signal to be an RW signal. Upon receiving arrival times of the DW and RW signals and the signal control time t0 of the controller 110, the signal analyzer 150 measures arrival times ta and tb of the DW signal and arrival times ta2 and tb2 of the RW signal, respectively.

Referring to FIGS. 2 to 4, upon receiving individual arrival times of the DW and RW signals and the signal control time t0 of the controller 110, the signal analyzer 150 calculates a difference between the arrival time of the DW signal and the signal control time t0, such that it can calculate the arrival times ta and tb of the DW signal. Also, the signal analyzer 150 calculates a difference between the arrival time of the RW signal and the signal control time t0, such that it can calculate the arrival times ta2 and tb2 of the RW signal. Therefore, the signal analyzer 150 transmits the calculated arrival times of the DW and RW signals to the position calculator 160. In this case, the reference character ta2 is indicative of a time of “t1+t2”, and the reference character tb2 is indicative of a time of “t1+t3”.

The position calculator 160 calculates touched positions x and y on the touch panel 101 upon receiving the arrival times ta, tb, ta2, and tb2 from the signal analyzer 150. In more detail, upon receiving arrival times ta, tb, ta2, and tb2 from the signal analyzer 150, the position calculator 160 calculates one position “x” of two positions x and y located on the touch panel 101 using the following equation 1, and calculates the other position “y” using the following equation 2:

$$\begin{matrix}x = \frac{[ ta * ta 2 ( ta 2 - tb 2 ) ( {tb}^{2} - tb {2}^{2} ) + ta 2 \sqrt{{ta}^{2} - ta {2}^{2}} * tb \sqrt{( {tb}^{2} - tb {2}^{2} ) ( {ta}^{2} - ta {2}^{2} + {tb}^{2} + 2 ta 2 * tb 2 - tb {2}^{2} )} + {ta}^{3} ( tb {2}^{2} - {tb}^{2} ) ] v}{2 ( ta {2}^{2} * {tb}^{2} + {ta}^{2} ( tb {2}^{2} - {tb}^{2} ) )} & [ Equation 1 ] \\ y = \frac{- ta * tb ( {tb}^{2} + ( ta 2 - tb 2 ) tb 2 ) + ta {2}^{2} tb ( {tb}^{2} + ( ta 2 - tb 2 ) tb 2 ) + ta \sqrt{{ta}^{2} - ta {2}^{2}} * tb 2 \sqrt{( {tb}^{2} - tb {2}^{2} ) ( {ta}^{2} - ta {2}^{2} + {tb}^{2} + 2 ta 2 * tb 2 - tb {2}^{2} ) v}}{2 ( ta {2}^{2} * {tb}^{2} + {ta}^{2} ( tb {2}^{2} - {tb}^{2} ) )} & [ Equation 2 ]\end{matrix}$$

As stated above, the touched-position detection device of the present invention has a more simplified configuration as compared to the conventional array sensor, reduces the number of used sensors, calculates coordinate information of a touched object (i.e., a contact object) on the basis of arrival time information of a SAW signal generated by the touched object, resulting in excellent resolution, a quick response time, and low power consumption.

As apparent from the above description, the present invention can trace position coordinate information of a touch panel using one SAW generator and at least two SAW sensors, such that it has a more simplified configuration as compared to the conventional array sensor, reduces the number of used sensors, calculates coordinate information of a touched object (i.e., a contact object) on the basis of arrival time information of a SAW signal generated by the touched object, resulting in excellent resolution, a quick response time, and low power consumption.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A touched-position detection device using a surface acoustic wave (SAW) signal, comprising:
a touch panel formed of a non-directional material associated with a SAW;
a controller for controlling signal generation and a signal generation time;
an impulse signal generator for generating an impulse signal upon receiving a control signal from the controller;
a SAW generator installed at one corner of the touch panel to convert the impulse signal generated from the impulse signal generator into a SAW signal on the touch panel;
a SAW sensor including piezoelectric vibration sensors installed at more than two points contained in the touch panel, each piezoelectric vibration sensor detecting the SAW signal received via the touch panel's surface;
a signal analyzer for classifying the SAW signal detected by the SAW sensor into a DW (Direct Surface Wave) signal and an RW (Reflected Surface Wave) signal according to intensity information of the SAW signal so as to identify the SAW signal, and measuring arrival times of the DW signal and other arrival times of the RW signal upon receiving arrival times of the DW and RW signals and the signal control time of the controller; and
a position calculator for calculating the touched positions x and y on the touch panel upon receiving the arrival times from the signal analyzer.

2. The touched-position detection device according to claim 1, wherein the touch panel is formed of a material having a low isotropic attenuation coefficient.

3. The touched-position detection device according to claim 1, wherein the SAW generator is formed of a piezoelectric ultrasound generator.

4. The touched-position detection device according to claim 1, wherein the signal analyzer, upon receiving individual arrival times of the DW and RW signals and the signal control time of the controller, calculates a difference between the arrival time of the DW signal and the signal control time so as to calculate the arrival times of the DW signal, and calculates a difference between the arrival time of the RW signal and the signal control time so as to calculate the arrival times of the RW signal.

5. The touched-position detection device according to claim 1, wherein the position calculator calculates touched positions x and y on the touch panel upon receiving the arrival times from the signal analyzer, in which
one position “x” located on the touch panel is calculated by the following equation,
$$x = \frac{[ ta * ta 2 ( ta 2 - tb 2 ) ( {tb}^{2} - {tb2}^{2} ) + ta 2 \sqrt{{ta}^{2} - ta {2}^{2}} * tb \sqrt{( {tb}^{2} - tb {2}^{2} ) ( {ta}^{2} - ta {2}^{2} + {tb}^{2} + 2 ta 2 * tb 2 - tb {2}^{2} )} + {ta}^{3} ( tb {2}^{2} - {tb}^{2} ) ] v}{2 ( ta {2}^{2} * {tb}^{2} + {ta}^{2} ( tb {2}^{2} - {tb}^{2} ) )} , and$$
the other position “y” is calculated by the following equation:
$$y = \frac{- ta * tb ( {tb}^{2} + ( ta 2 - tb 2 ) tb 2 ) + ta {2}^{2} tb ( {tb}^{2} + ( ta 2 - tb 2 ) tb 2 ) + ta \sqrt{{ta}^{2} - ta {2}^{2}} * tb 2 \sqrt{( {tb}^{2} - tb {2}^{2} ) ( {ta}^{2} - ta {2}^{2} + {tb}^{2} + 2 ta 2 * tb 2 - tb {2}^{2} ) v}}{2 ( ta {2}^{2} * {tb}^{2} + {ta}^{2} ( tb {2}^{2} - {tb}^{2} ) )}$$
